(19) United States
(12) Patent Application Publication
(10) Pub. No.: US 2017/0347175 A1
(43) Pub. Date: Nov. 30, 2017

(54) MICROPHONE CLAMP FOR MUSICAL INSTRUMENT

(71) Applicants: Jean LACHANCE, Webbwood (CA); Matthew LACHANCE, Webbwood (CA)

(72) Inventors: Jean LACHANCE, Webbwood (CA); Matthew LACHANCE, Webbwood (CA)

(21) Appl. No.: 15/168,622

(22) Filed: May 31, 2016

(51) Int. Cl. H04R 1/08; F16B 2/12; F16B 2/06

(52) U.S. Cl. CPC H04R 1/08; F16B 2/065; F16B 2/12

(57) ABSTRACT

An apparatus includes a clamp configured to selectively securely clamp to, and to selectively unclamp from, a musical instrument. A boom support is configured to securely receive and support a microphone boom relative to the clamp. The microphone boom is configured to selectively securely attach to, and to selectively detach from, a microphone support. The microphone support is configured to securely receive and support a microphone relative to the musical drum. A lock is configured to selectively securely lock the boom support and the clamp to each other. The lock is also configured to selectively unlock the boom support and the clamp from each other.

### TECHNICAL FIELD

This document relates to the technical field of (and is not limited to) a microphone clamp for use with a musical instrument, such as a musical drum.

### BACKGROUND

A musical instrument is an instrument created or adapted to make musical sounds, such as a musical drum. A drum kit (also called a drum set, a trap set, or drums) is a collection of musical drums and other percussion instruments, typically cymbals, which are set up on stands to be played by a player (a musician) with drumsticks held in both hands, with the feet of the player operating pedals that control the hi-hat cymbal and the beater for the bass drum.

### SUMMARY

It will be appreciated that there exists a need to mitigate (at least in part) at least one problem associated with devices (also called the existing technology) configured for the placement of microphones proximate to a musical instrument, such as a drum kit. After much study of the known systems and methods with experimentation, an understanding of the problem and its solution has been identified and is articulated as follows:

For instance, microphones are used with a drum kit to pick up the sound of the musical drums and/or cymbals for a sound recording and/or for sound amplification through a sound reinforcement system. Most drummers use microphones and amplification in live shows so that the sound engineer can adjust and balance the sound levels of the musical drums and/or cymbals for a desired artistic effect during a musical performance or recording. A middle ground approach is used in which not every drum and cymbal have a dedicated microphone, but rather a selected one or two components may have a microphone. In this manner, microphones may be used with only the instruments that the sound engineer wants to be able to control in the sounds mix.

Condenser-type microphones are utilized for overheads and room mics, which is an approach that is more common with sound recording applications.

Dynamic-type microphones are predominantly utilized with musical instruments (such as a musical drum) for live shows. This type of microphone is positioned very close to the musical instrument. For this case, the microphone is positioned by using a stand or by mounting the microphone (on the rim of the musical drum, for instance), etc. Positioning a microphone in close proximity to a musical instrument may be challenging in terms of ease of set-up and knock-down and/or ease of spatial positioning of the microphone relative to the musical instrument.

To mitigate, at least in part, at least one problem associated with the existing technology, there is provided (in accordance with a major aspect) an apparatus. The apparatus includes a clamp configured to (A) selectively securely clamp (at least in part) to a musical instrument, and (B) selectively unclamp from the musical instrument (such as, a musical drum of a musical drum kit).

The apparatus also includes a boom support configured to (A) securely receive (at least in part) a microphone boom relative to the clamp, and (B) securely support (at least in part) the microphone boom relative to the clamp. The microphone boom is configured to selectively securely attach, at least in part, to, and to selectively detach from, a microphone support. The microphone support is configured to securely receive, at least in part, and securely support, at least in part, a microphone relative to the musical instrument (such as, the musical drum).

The apparatus also includes a lock configured to selectively securely lock, at least in part, the boom support and the clamp to each other. This is done in such a way that the boom support and the clamp are affixed, at least in part, together and are not movable relative to each other. The lock is also configured to selectively unlock the boom support and the clamp from each other. This is done in such a way that the boom support and the clamp are not affixed together and are movable relative to each other.

Other aspects are identified in the claims.

Other aspects and features of the non-limiting embodiments may now become apparent to those skilled in the art upon review of the following detailed description of the non-limiting embodiments with the accompanying drawings.

This Summary is provided to introduce concepts in simplified form that are further described below in the Detailed Description. This Summary is not intended to identify key features or essential features of the disclosed or claimed subject matter, and is not intended to describe each disclosed embodiment or every implementation of the disclosed or claimed subject matter, and is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a perspective view of an embodiment of a musical instrument, such as a musical drum kit including a musical drum;

FIG. 2, FIG. 3 and FIG. 4 depict perspective views of embodiments of an apparatus for use with the musical drum of the musical drum kit of FIG. 1;

FIG. 5 to FIG. 21 depict views of embodiments of a clamp of the apparatus of FIG. 2;

FIG. 22 to FIG. 28 depict views of embodiments of a boom support of the apparatus of FIG. 2;

FIG. 29 to FIG. 32 depict views of embodiments of a microphone boom of the apparatus of FIG. 2;

FIG. 33 to FIG. 35 depict views of embodiments of a lock of the apparatus of FIG. 2; and

FIG. 36 to FIG. 38 depict views of embodiments of the apparatus of FIG. 2.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

LISTING OF REFERENCE NUMERALS USED IN THE DRAWINGS
100 apparatus
102 microphone boom
104 clamp
106 boom support
108 lock
110 key
111 finger portions
112 lock axis
113 bolt-head receiver
114 translation axis
116 radial direction
118 jaw-movement axis
120 clamp body
122 clamp-bolt receiver
123 jaw-bolt receiver
124 lock-bolt receiver
126 jaw groove
128 surface groove
130 jaw portion
131 jaw groove
132 clamp bolt
133 end portion
134 clamp biasing device
135 washer
136 surface channel
137 distal end
139 step
140 first body
142 second body
144 first passageway
146 second passageway
148 boom passageway
150 first outer channel
152 second outer channel
154 bud portion
156 lock body
158 protrusion
160 bolt receiver
162 lock bolt
164 shaped-head section
166 washer
168 distal end
900 musical drum
902 musical drum kit
904 microphone support
906 microphone
908 rim section

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims (in which the claims may be amended during patent examination after filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

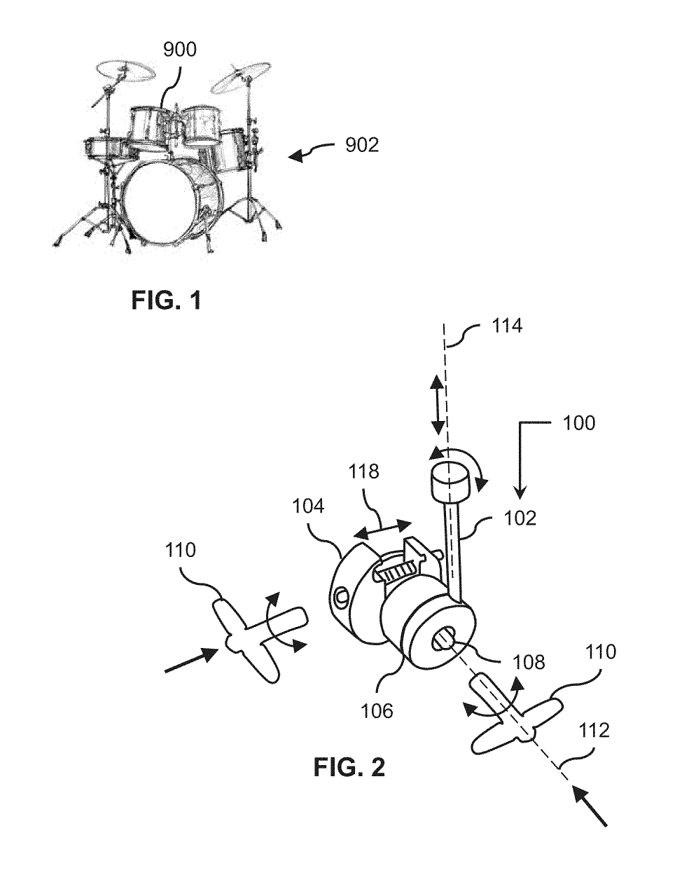

FIG. 1 depicts a perspective view of an embodiment of a musical instrument, such as, and not limited to, a musical drum kit 902 including a musical drum 900.

Referring to the embodiment as depicted in FIG. 1, the musical drum kit 902 includes an acoustic drum kit having various types of the musical drum 900 (such as, the snare drum, the bass drum, the toms), etc., and also having the splash cymbal, the crash cymbal, the hi-hat cymbal, the ride cymbal, etc.

FIG. 2, FIG. 3 and FIG. 4 depict perspective views of embodiments of an apparatus 100 for use with the musical drum 900 of the musical drum kit 902 of FIG. 1.

Referring to the embodiment as depicted in FIG. 2, the apparatus 100 may be called a microphone clamp apparatus or a microphone clamp, etc., and any equivalent thereof.

In accordance with a first major embodiment, the apparatus 100 includes (and is not limited to) a synergistic combination of a clamp 104 (also called a clamp assembly), a microphone boom 102 (also called a microphone-boom assembly or a boom assembly), a boom support 106 (also called a boom support assembly), and a lock 108 (also called a lock assembly or a clamp-lock assembly).

In accordance with a second major embodiment, the apparatus 100 includes (and is not limited to) a synergistic combination of a clamp 104, a boom support 106 and a lock 108. For the second major embodiment, a microphone boom 102 is not provided with the apparatus 100, and the microphone boom 102 may be provided by (for example) the user for use with the boom support 106 of the apparatus 100.

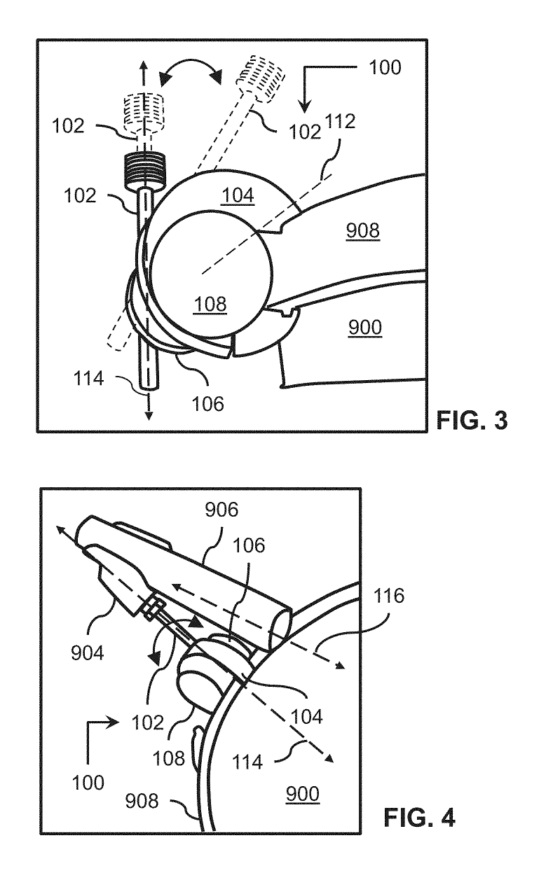

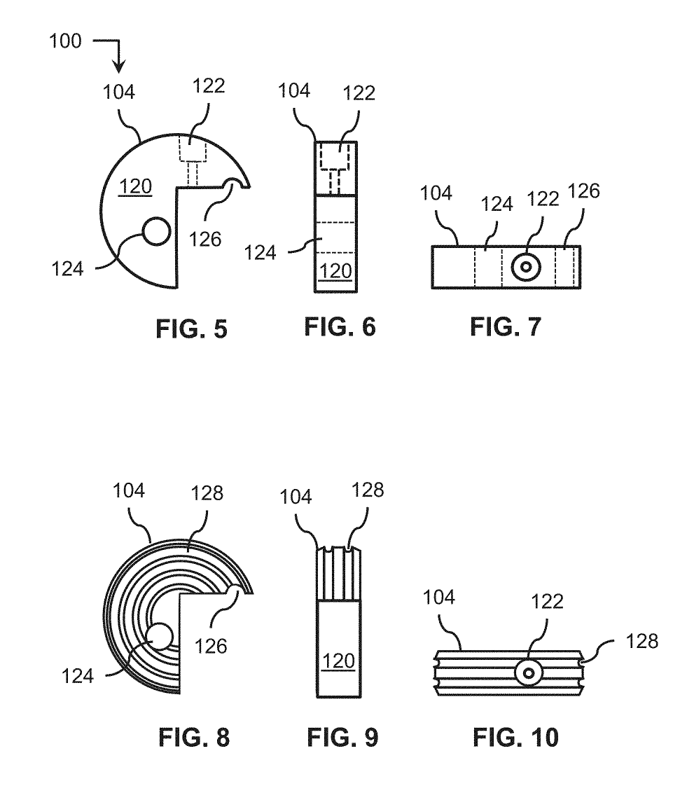

The clamp 104 is configured to (A) selectively securely clamp (either directly or indirectly), at least in part, to the musical instrument (such as, the musical drum 900 of the musical drum kit 902), and (B) selectively unclamp from the musical instrument (such as, the musical drum 900 of the musical drum kit 902, as depicted in FIG. 1). In accordance with a preferred embodiment, the clamp 104 is configured to (A) securely attach (either directly or indirectly), at least in part, to the musical drum 900 of the musical drum kit 902, and (B) selectively detach from, the musical drum 900 of the musical drum kit 902 (as depicted in FIG. 1). It will be appreciated that FIG. 5 to FIG. 21 depict views of embodiments of the clamp 104.

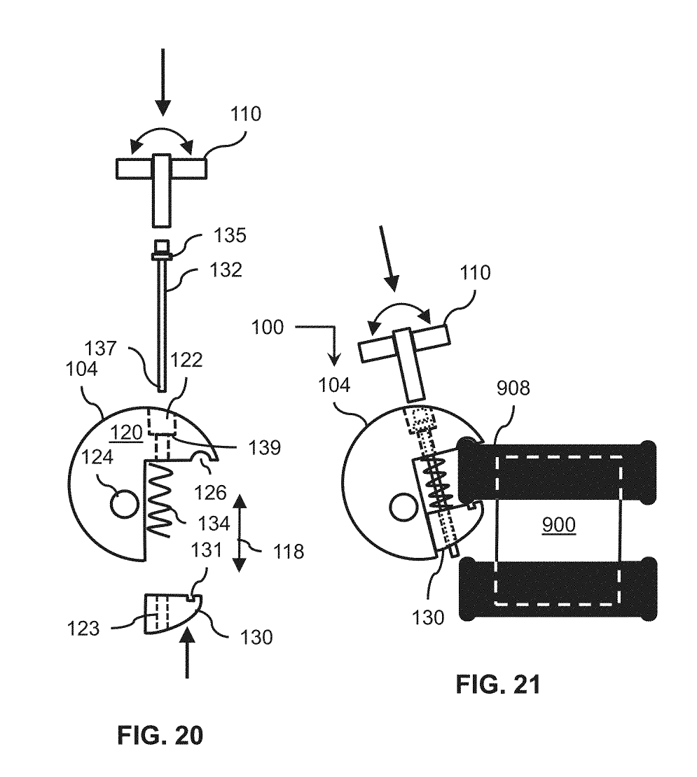

In accordance with a preferred embodiment, a key 110 (also called a key assembly and any equivalent thereof) is configured to (A) couple (either directly or indirectly) to a portion of the clamp 104, and (B) operate the clamp 104. More specifically, the key 110 is configured to open and close a pair of opposed jaws of the clamp 104. This is done in such a way that the opposed clamp jaws of the clamp 104 are securely connectable to, and disconnectable from, the musical instrument (such as, the musical drum 900), as described in connection with the embodiments as depicted in FIGS. 20 and 21. The pair of opposed jaws of the clamp 104 are movable along a jaw-movement axis 118 (as depicted in FIGS. 2, 20 and 38).

The microphone boom 102 is configured to (A) selectively securely attach (either directly or indirectly), at least in part, to a microphone support 904, and (B) selectively detach from the microphone support 904 (also called a microphone connector, and any equivalent thereof, as depicted in FIG. 4).

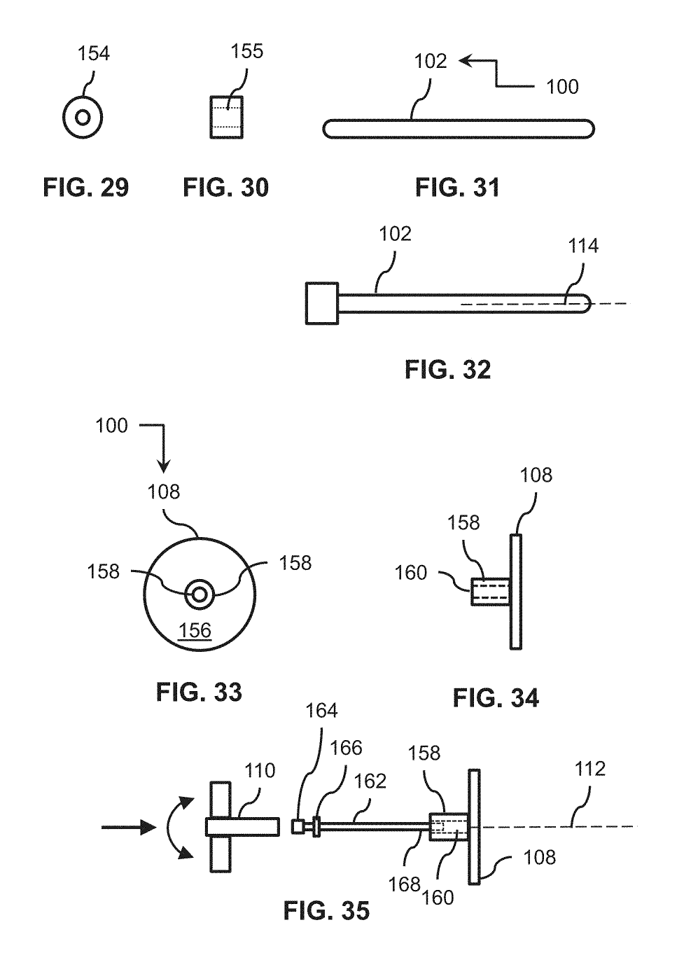

The microphone support 904 is configured to (A) securely receive (either directly or indirectly), at least in part, a microphone 906, and (B) securely support (either directly or indirectly), at least in part, the microphone 906 (as depicted in FIG. 4) relative to the musical instrument (such as, the musical drum 900). More preferably, the microphone support 904 is configured to (A) securely receive (either directly or indirectly), at least in part, an outer body of the microphone 906, and (B) securely support (either directly or indirectly), at least in part, the outer body of the microphone 906 (as depicted in FIG. 4). It will be appreciated that FIG. 29 to FIG. 32 depict views of embodiments of the microphone boom 102.

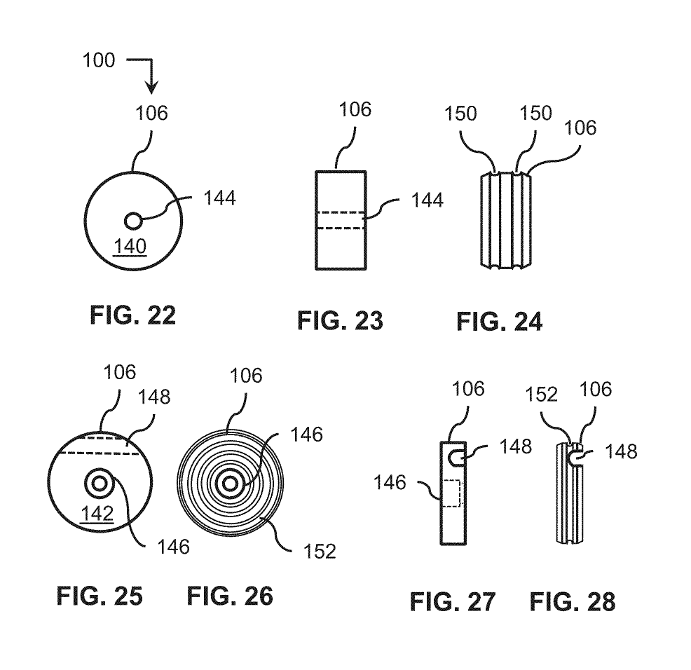

The boom support 106 is configured to (A) securely receive (either directly or indirectly), at least in part, the microphone boom 102 relative to the clamp 104, and (B) securely support (either directly or indirectly), at least in part, the microphone boom 102 relative to the clamp 104. It will be appreciated that FIG. 22 to FIG. 28 depict views of embodiments of the boom support 106. For the case where the boom support 106 does not securely receive and securely support the microphone boom 102 relative to the clamp 104, the microphone boom 102 is freely movable (free to be movable) and may be linearly translated relative to the boom support 106 (or to be moved away from the boom support 106) along a translation axis 114 (as depicted in FIGS. 2, 3 and 38). The translation axis 114 is aligned substantially perpendicularly to a lock axis 112 (as depicted in FIGS. 2, 36 and 38). The lock axis 112 extends axially through the lock 108. Preferably, for the case where the boom support 106 does not securely receive and securely support the microphone boom 102 relative to the clamp 104, the microphone boom 102 is freely rotatable (free to be rotatable) relative to the translation axis 114.

The lock 108 is configured to selectively securely lock (either directly or indirectly), at least in part, the boom support 106 and the clamp 104 to each other. This is done in such a way that the boom support 106 and the clamp 104 are affixed (either directly or indirectly), at least in part, together and are not movable relative to each other (once the lock 108 is engaged). The lock 108 is also configured to selectively unlock the boom support 106 and the clamp 104 from each other. This is done in such a way that the boom support 106 and the clamp 104 are not affixed together and are movable relative to each other (once the lock 108 is disengaged or disabled). It will be appreciated that FIG. 33 to FIG. 35 depict views of embodiments of the lock 108.

In accordance with a preferred embodiment, the key 110 is configured to couple (either directly or indirectly) to a portion of the lock 108, and to operate the lock 108. More specifically, the key 110 is configured to urge the lock 108 to lock the boom support 106 and the clamp 104 together in an affixed relationship. Preferably, the key 110 is used for both the clamp 104 and the lock 108 (for convenience). It will be appreciated that separate types of keys may be with the clamp 104 and the lock 108 (respectively) if required. The microphone boom 102 is configured to be rotatable relative to a lock axis 112 that extends axially through the lock 108.

Referring to the embodiment as depicted in FIG. 3, the clamp 104 is configured to be affixed to a rim section 908 of the musical drum 900.

The lock 108 is configured to unlock the microphone boom 102 from the boom support 106 in such a way that the microphone boom 102 is rotatable relative to the lock axis 112 extending axially through the lock 108 (preferably while the clamp 104 remains connected (securely affixed) to the musical drum 900). In this manner, the microphone 906 may be positioned relative to the musical drum 900 (as required for preferred acoustic pick up of music from the musical drum 900).

The lock 108 is also configured to unlock the microphone boom 102 from the boom support 106 in such a way that the microphone boom 102 is linearly movable (translatable) along the translation axis 114 that is substantially perpendicular to the lock axis 112 extending axially through the lock 108 (preferably while the clamp 104 remains connected or securely affixed to the musical drum 900). In this manner, the microphone 906 may be positioned relative to the musical drum 900 (as required for preferred acoustic pick up of music from the musical drum 900).

Referring to the embodiment as depicted in FIG. 4, the boom support 106 is configured to receive, at least in part, and support, at least in part, the microphone boom 102 relative to the musical drum 900 and the clamp 104. This is done in such a way that the boom support 106, in use, facilitates selective relative movement of the microphone boom 102 relative to the musical drum 900 (preferably while the clamp 104 remains connected or securely affixed to the musical drum 900).

More preferably, the boom support 106 is configured to facilitate: (A) linear sliding movement of the microphone boom 102 (preferably along the translation axis 114), (B) positioning of the microphone boom 102 at positions located along an axial length of the microphone boom 102 (preferably along the translation axis 114), and (C) rotating of the microphone boom 102 along (about) the axis of the microphone boom 102 (preferably about the translation axis 114).

Preferably, the microphone support 904 is configured to permit linear movement of the microphone 906 along a radial direction 116 (as depicted in FIG. 4) extending radially from the musical drum 900.

FIG. 5 to FIG. 21 depict views of embodiments of a clamp 104 of the apparatus 100 of FIG. 2. FIGS. 5, 8, 11, 14, 16, 17, 19, 21 and 22 depict side views. FIGS. 6, 9, 12 and 15 depict front views. FIGS. 7, 10, 13 and 18 depict top views.

Referring to the embodiments as depicted in FIGS. 5 to 10, the clamp 104 defines a clamp body 120. Preferably, the clamp body 120 forms a cylindrical shaped body defining a right-angled notch positioned at a quarter quadrant of the clamp body 120.

The clamp body 120 defines a clamp-bolt receiver 122 (channel). The clamp-bolt receiver 122 enters an outer circumferential peripheral edge of the clamp body 120. The clamp-bolt receiver 122 is spaced apart from (off axis from) a central axis of the clamp body 120. The clamp-bolt receiver 122 is aligned at a right angle relative to the central axis of the clamp body 120. The clamp-bolt receiver 122 is configured to receive the clamp bolt 132 (as depicted in FIG. 17).

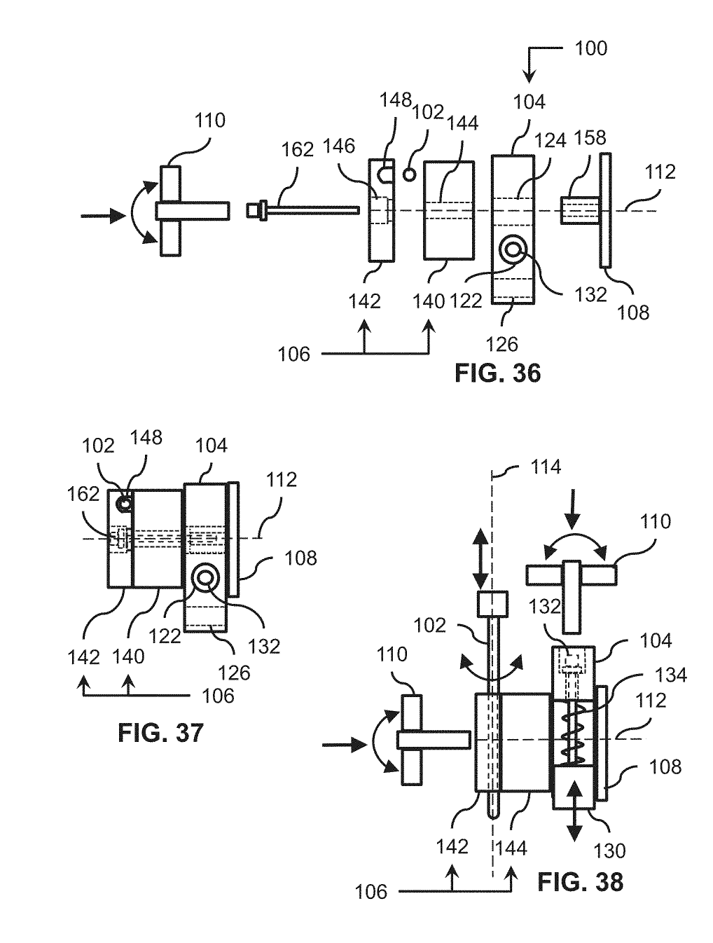

The clamp body 120 defines a lock-bolt receiver 124. The lock-bolt receiver 124 extends between opposite lateral sides of the clamp body 120. The lock-bolt receiver 124 is spaced apart from (off axis from) a central axis of the clamp body 120, and is aligned along the same direction as the central axis of the clamp body 120. The lock-bolt receiver 124 is configured to receive the protrusion 158 of the lock 108 (and to receive, at least in part, the lock bolt 162) as depicted in FIG. 35. The lock-bolt receiver 124 extends along the lock axis 112, once the lock-bolt receiver 124 receives, at least in part, the lock 108, as depicted in FIG. 36.

The clamp body 120 defines a jaw groove 126. The jaw groove 126 extends between opposite lateral sides of the clamp body 120. The jaw groove 126 is formed on a surface of the right-angled notch at the quarter quadrant of the clamp body 120. The jaw groove 126 is spaced apart from (off axis from) a central axis of the clamp body 120, and is aligned along the same direction as the central axis of the clamp body 120. The jaw groove 126 is configured to engage the rim section 908 as depicted in FIG. 21.

The clamp body 120 defines a surface groove 128. The surface groove 128 is configured to facilitate tactile grip of the clamp body 120 by the user (if so desired). In accordance with an embodiment, the surface groove 128 is formed on the opposite lateral sides of the clamp body 120 (as depicted in FIG. 8). Preferably, a plurality of concentrically positioned instances of the surface groove 128 is formed on the opposite lateral sides of the clamp body 120. In accordance with an embodiment, the surface groove 128 is formed on the outer circumferential peripheral edge of the clamp body 120 (as depicted in FIG. 9). Preferably, a plurality of concentrically positioned instances of the surface groove 128 is formed on the outer circumferential peripheral edge of the clamp body 120.

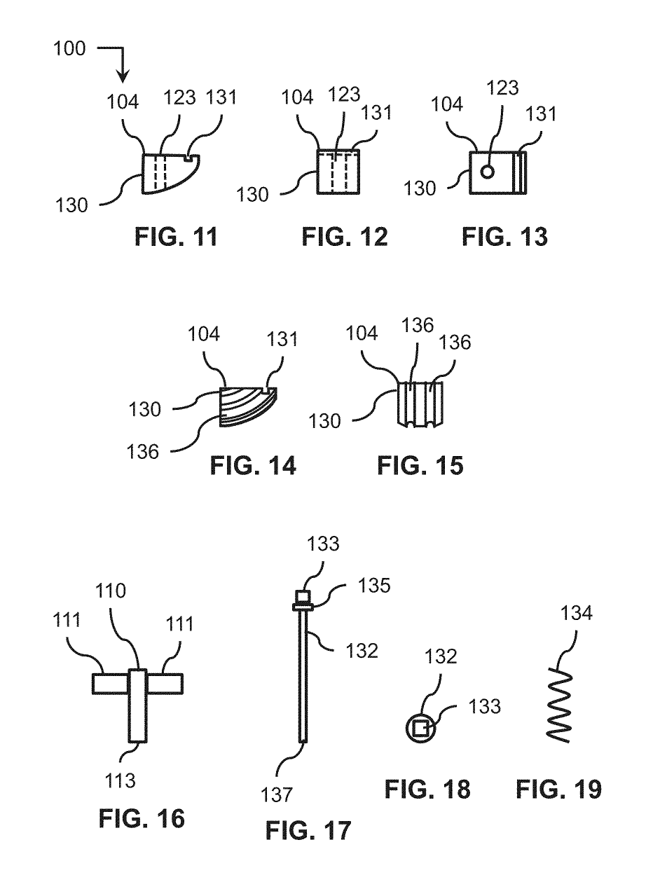

Referring to the embodiments as depicted in FIGS. 11 to 15, the clamp 104 includes a jaw portion 130. The jaw portion 130 is movable relative to the clamp body 120 (as depicted in FIG. 5) of the clamp 104. The jaw portion 130 defines a jaw-bolt receiver 123. The jaw-bolt receiver 123 extends through the jaw portion 130. The jaw-bolt receiver 123 is configured to receive the clamp bolt 132 (as depicted in FIG. 17).

The jaw portion 130 defines a jaw groove 131. The jaw groove 131 is configured to engage the rim section 908 (as depicted in FIG. 21). The clamp 104 defines a surface channel 136. The surface channel 136 is configured to facilitate tactile grip of the clamp body 120 by the user (if so desired).

Referring to the embodiment as depicted in FIG. 16, the key 110 includes a key body having finger portions 111 extending radially from opposite sides of the key body. The key 110 defines a bolt-head receiver 113 configured to receive an end portion 133 of the clamp bolt 132 (as depicted in FIG. 17). Preferably, the end portion 133 defines a shape, such as a square-shape protrusion as depicted in the embodiment of FIG. 18.

Referring to the embodiment as depicted in FIGS. 17 and 18, the clamp 104 includes a clamp bolt 132. The clamp bolt 132 is configured to (A) extend through, at least in part, the jaw-bolt receiver 123 defined by the jaw portion 130 (as depicted in FIG. 11), and (B) extend through, at least in part, the clamp-bolt receiver 122 defined by the clamp body 120 of the clamp 104 (as depicted in FIG. 5). A washer 135 is positioned against the end portion 133 (head end portion). The clamp bolt 132 defines external threads (formed on the elongated outer body of the clamp bolt 132) that extend from a distal end 137 toward the end portion 133. The external threads of the clamp bolt 132 are threadably engageable with the jaw-bolt receiver 123 of the jaw portion 130. Preferably, the external threads of the clamp bolt 132 are not threadably engageable with the clamp-bolt receiver 122 of the clamp body 120.

Referring to the embodiment as depicted in FIG. 19, the clamp 104 includes a clamp biasing device 134 configured to interact with the jaw portion 130. Preferably, the clamp biasing device 134 includes a spring assembly, etc., and any equivalent thereof. The clamp bolt 132 (as depicted in FIG. 17) is configured to extend through a central opening defined by the clamp biasing device 134.

Referring to the embodiment as depicted in FIG. 20, the clamp biasing device 134 is positioned on one side of the clamp-bolt receiver 122 (within the right-angled notch positioned at a quarter quadrant of the clamp body 120). The clamp biasing device 134 is coaxially aligned with the clamp-bolt receiver 122. The clamp bolt 132 is inserted into the clamp-bolt receiver 122 defined by the clamp body 120 of the clamp 104. This is done in such a way that (A) the washer 135 abuts a step 139 defined within the clamp-bolt receiver 122, and (B) the clamp-bolt receiver 122 extends through the central open section of the clamp biasing device 134. The distal end 137 of the clamp bolt 132 is threadably engaged with the internal threads defined by the jaw-bolt receiver 123 of the jaw portion 130. The jaw portion 130 is thread engageable with the clamp bolt 132. Rotating the key 110 in one direction causes the jaw portion 130 to threadably translate along and slidably contact the clamp body 120 toward the clamp-bolt receiver 122. In this manner, the clamp biasing device 134 becomes compressed (stressed). Rotating the key 110 in an opposite direction causes the jaw portion 130 to translate along the clamp body 120 and away from the clamp-bolt receiver 122, in which the clamp biasing device 134 is configured to push (assist in moving) the jaw portion 130 away from the clamp-bolt receiver 122. In this manner, the clamp biasing device 134 becomes decompressed (unstressed).

Referring to the embodiment as depicted in FIG. 21, the clamp 104 is configured to securely couple to the rim section 908 of the musical drum 900. The jaw groove 126 and the jaw groove 131 engage opposite edges of the rim section 908. The jaw groove 126 is made to engage one side of the rim section 908, and the jaw groove 131 is made to engage the opposite lateral side of the rim section 908 (once the jaw portion 130 is made to move toward the clamp-bolt receiver 122 defined by the clamp body 120 of the clamp 104).

FIG. 22 to FIG. 28 depict views of embodiments of a boom support 106 of the apparatus 100 of FIG. 2. FIGS. 22, 25 and 26 depict side views. FIGS. 23, 24, 27 and 28 depict front views.

The boom support 106 includes a first body 140 (as depicted in FIG. 22) and a second body 142 (as depicted in FIG. 25). Preferably, the first body 140 and the second body 142 each includes a cylindrical-shaped body.

The first body 140 defines a first passageway 144 extending through the central axis of the first body 140. The first passageway 144 extends along the lock axis 112, once the first passageway 144 receives, at least in part, the lock 108, as depicted in FIG. 36.

The second body 142 defines a second passageway 146 extending through the central axis of the second body 142. The second passageway 146 extends along the lock axis 112, once the second passageway 146 receives, at least in part, the lock 108, as depicted in FIG. 36.

The second body 142 defines a boom passageway 148. The boom passageway 148 is configured to receive, at least in part, a length of the microphone boom 102 (as depicted in FIG. 32). The boom passageway 148 extends along a direction that is spaced apart from the central axis of the second body 142. The boom passageway 148 extends at a right angle to the central axis of the second body 142. The boom passageway 148 extends from the outer peripheral circumferential edge on one side of the second body 142 to another side of the second body 142.

In accordance with a preferred embodiment (as depicted in FIG. 24), the first body 140 defines a first outer channel 150. The first outer channel 150 is configured to facilitate tactile grip of the first body 140 by the user (if so desired).

In accordance with a preferred embodiment (as depicted in FIGS. 26 and 28), the second body 142 defines a second outer channel 152. The second outer channel 152 is configured to facilitate tactile grip of the second body 142 by the user (if so desired).

The opposite lateral side faces of the first body 140 are flat. One flat side face of the first body 140 is for abutment against (contact with) a flat side face of the clamp 104. One lateral side face of the second body 142 is flat, and is for abutment against another flat side face of the first body 140. Another lateral side face of the second body 142 may define the second outer channel 152 (if so desired).

FIG. 29 to FIG. 32 depict views of embodiments of a microphone boom 102 of the apparatus 100 of FIG. 2. FIG. 29 depicts a top view. FIG. 30 to FIG. 32 depict front views.

Referring to the embodiments as depicted in FIGS. 29 to 32, the microphone boom 102 includes an elongated shaft member. A bud portion 154 is affixed (securely connected) to an end portion of the elongated shaft member of the microphone boom 102. The bud portion 154 defines an internal hole configured to receive, at least in part, the elongated shaft member of the microphone boom 102. The bud portion 154 defines external threads configured to be threadably connected to the microphone support 904 (as depicted in FIG. 4).

FIG. 33 to FIG. 35 depict views of embodiments of a lock 108 of the apparatus 100 of FIG. 2. FIG. 33 depicts a side view. FIG. 34 and FIG. 35 depict front views.

Referring to the embodiments as depicted in FIGS. 33, 34 and 35, the lock 108 includes a lock body 156. The lock body 156 includes a disk-shaped body. A protrusion 158 extends from the lock body 156. The protrusion 158 defines a bolt receiver 160 having interior threads therein. The bolt receiver 160 is configured to receive, at least in part, a lock bolt 162. The lock bolt 162 includes a shaped-head section 164 extending from a shaft portion defining exterior threads thereon. The exterior threads of the lock bolt 162 are configured to engage the interior threads of the bolt receiver 160. A washer 166 is installed to the shaft portion of the lock bolt 162. A distal end 168 is configured to threadably connect to the interior of the bolt receiver 160. The key 110 is configured to engage the shaped-head section 164. Preferably, the shaped-head section 164 defines a square-shaped protrusion, and the key 110 defines a square-shaped interior recess configured to couple to the square-shaped protrusion of the shaped-head section 164.

FIG. 36 to FIG. 38 depict views of embodiments of the apparatus 100 of FIG. 2. FIG. 36 depicts a top view (in which the apparatus 100 is exploded). FIG. 37 depicts a top view (in which the apparatus 100 is assembled). FIG. 38 depicts a side view (in which the apparatus 100 is assembled).

Referring to the embodiments as depicted in FIGS. 36 to 38, the lock 108 is configured to selectively unlock the clamp 104 and the boom support 106 from each other. This is done in such a way that the microphone boom 102 is permitted to (A) slide along the axial length of the microphone boom 102, and (B) rotate along the axis of the microphone boom 102.

In accordance with a preferred embodiment, the lock 108 is configured to selectively lock the clamp 104 and the boom support 106 to each other. This is done in such a way that the microphone boom 102 is (A) prevented from sliding along the axial length of the microphone boom 102, and (B) prevented from rotating along the axis of the microphone boom 102.

Referring to the embodiment as depicted in FIG. 36, the clamp 104, the boom support 106 and the lock 108 are coaxially aligned along the lock axis 112. This is done in such a way that the second passageway 146 (of the second body 142), the first passageway 144 (of the first body 140), and the lock-bolt receiver 124 (of the clamp 104) are centrally aligned (centrally coaxially aligned) along the lock axis 112. The protrusion 158 (of the lock 108) is receivable (at least in part) in the lock-bolt receiver 124 of the clamp 104. The microphone boom 102 is received (at least in part) in the boom passageway 148. The lock bolt 162 is slidably received in the second passageway 146, the first passageway 144, and the lock-bolt receiver 124. The lock bolt 162 is threadably coupled to the protrusion 158 of the lock 108. The lock bolt 162 is configured to be tightened by rotation of the key 110.

Referring to the embodiment as depicted in FIG. 37, the lock bolt 162 is configured to be tightened by rotation of the key 110 until the second body 142 securely contacts (abuts) the first body 140 in a locked relationship. This is done in such a way that (A) the microphone boom 102 is received and is securely trapped in the boom passageway 148 because the outer circumferential edge of the microphone boom 102 contacts the first body 140 and the second body 142 while positioned in the boom passageway 148, and (B) the first body 140 of the boom support 106 abuts (securely contacts) the clamp 104 so that the boom support 106 and the clamp 104 cannot rotate relative to each other.

Referring to the embodiment as depicted in FIG. 38, the key 110 is positioned to rotate the clamp bolt 132 in such a way that the clamp bolt 132 rotates and threadably engages the jaw portion 130. The jaw portion 130 translates linearly along the axis extending through the clamp bolt 132. The clamp bolt 132 remains stationary relative to the clamp 104 while the key 110 rotates the clamp bolt 132 (in order to translate the jaw portion 130 along the jaw-movement axis 118).

It will be appreciated that the description identifies and describes options and variations of the apparatus 100, regardless of whether the description identifies the options and/or variations of the apparatus 100 by way of explicit terms and/or non-explicit terms. Other options for the apparatus 100 as identified in this paragraph may include any combination and/or permutation of the technical features (assemblies, components, items, devices, etc.) as identified in the detailed description, as may be required and/or desired to suit a particular technical purpose and/or technical function. It will be appreciated, that where possible, any one or more of the technical features and/or any one or more sections of the technical features of the apparatus 100 may be combined with any other one or more of the technical features and/or any other one or more sections of the technical features of the apparatus 100 in any combination and/or permutation. Any one or more of the technical features and/or any one or more sections of the technical features of the apparatus 100 may stand on its own merit without having to be combined with another technical feature. It will be appreciated that persons skilled in the art would know that technical features of each embodiment may be deployed (where possible) in other embodiments even if not expressly stated as such above. It will be appreciated that persons skilled in the art would know that other options would be possible for the configuration of the components of the apparatus 100 (if so desired) to adjust to manufacturing requirements and still remain within the scope of the invention as described in at least one or more of the claims. This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims. It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a clamp being configured to selectively securely clamp, at least in part, to a musical instrument, and to selectively unclamp from the musical instrument; and
a boom support being configured to securely receive, at least in part, a microphone boom relative to the clamp, and securely support, at least in part, the microphone boom relative to the clamp, in which the microphone boom is configured to selectively securely attach, at least in part, to, and to selectively detach from, a microphone support, in which the microphone support is configured to securely receive, at least in part, and securely support, at least in part, a microphone relative to the musical instrument; and
a lock being configured to selectively securely lock, at least in part, the boom support and the clamp to each other in such a way that the boom support and the clamp are affixed, at least in part, together and are not movable relative to each other; and
the lock also being configured to selectively unlock the boom support and the clamp from each other in such a way that the boom support and the clamp are not affixed together and are movable relative to each other.

2. An apparatus, comprising:
a clamp being configured to selectively securely clamp, at least in part, to a musical drum of a musical drum kit, and to selectively unclamp from the musical drum of the musical drum kit; and
a boom support being configured to securely receive, at least in part, a microphone boom relative to the clamp, and securely support, at least in part, the microphone boom relative to the clamp, in which the microphone boom is configured to selectively securely attach, at least in part, to, and to selectively detach from, a microphone support, in which the microphone support is configured to securely receive, at least in part, and securely support, at least in part, a microphone relative to the musical drum; and
a lock being configured to selectively securely lock, at least in part, the boom support and the clamp to each other in such a way that the boom support and the clamp are affixed, at least in part, together and are not movable relative to each other; and
the lock also being configured to selectively unlock the boom support and the clamp from each other in such a way that the boom support and the clamp are not affixed together and are movable relative to each other.

3. An apparatus, comprising:
a clamp being configured to selectively securely clamp, at least in part, to a musical drum of a musical drum kit, and to selectively unclamp from the musical drum of the musical drum kit; and
a microphone boom being configured to selectively securely attach, at least in part, to a microphone support, and to selectively detach from the microphone support, in which the microphone support is configured to securely receive, at least in part, and securely support, at least in part, a microphone relative to the musical drum; and
a boom support being configured to securely receive, at least in part, and securely support, at least in part, the microphone boom relative to the clamp; and
a lock being configured to selectively securely lock, at least in part, the boom support and the clamp to each other in such a way that the boom support and the clamp are affixed, at least in part, together and are not movable relative to each other; and
the lock also being configured to selectively unlock the boom support and the clamp from each other in such a way that the boom support and the clamp are not affixed together and are movable relative to each other.

4. The apparatus of claim 3, wherein:
the boom support is configured to receive, at least in part, and support, at least in part, the microphone boom relative to the musical drum and the clamp in such a way that the boom support, in use, facilitates selective relative movement of the microphone boom relative to the musical drum.

5. The apparatus of claim 3, wherein:
the boom support is configured to facilitate:
linear sliding movement of the microphone boom;
positioning of the microphone boom at positions located along an axial length of the microphone boom; and
rotating of the microphone boom along an axis of the microphone boom.

6. The apparatus of claim 3, wherein:
the lock is configured to selectively unlock the clamp and the boom support from each other in such a way that the microphone boom is permitted to:
slide along an axial length of the microphone boom; and
rotate along an axis of the microphone boom.

7. The apparatus of claim 3, wherein:
where the boom support does not securely receive and securely support the microphone boom relative to the clamp, the microphone boom is freely movable and is linearly translated relative to the boom support along a translation axis; and
where the boom support does not securely receive and securely support the microphone boom relative to the clamp, the microphone boom is freely rotatable relative to the translation axis; and
the translation axis is aligned substantially perpendicularly to a lock axis extending axially through the lock; and
the microphone boom is configured to be rotatable relative to the lock axis that extends axially through the lock.

8. The apparatus of claim 3, wherein:
a key is configured to couple to a portion of the clamp, and operate the clamp; and
the key is configured to open and close a pair of opposed jaws of the clamp in such a way that the clamp is securely connectable to, and disconnectable from, the musical drum.

9. The apparatus of claim 8, wherein:
the key is configured to couple to a portion of the lock, and to operate the lock; and
the key is configured to urge the lock to lock the boom support and the clamp together in an affixed relationship.

10. The apparatus of claim 3, wherein:
the lock is configured to unlock the microphone boom from the boom support in such a way that the microphone boom is rotatable relative to a lock axis extending axially through the lock, and in this manner, the microphone is positionable relative to the musical drum; and
the lock is also configured to unlock the microphone boom from the boom support in such a way that the microphone boom is linearly movable along a translation axis that is substantially perpendicular to the lock axis extending axially through the lock.

11. The apparatus of claim 3, wherein:
the clamp is configured to be affixed to a rim section of the musical drum.

12. The apparatus of claim 3, wherein:
the clamp defines a clamp body; and
the clamp body defines a clamp-bolt receiver; and
the clamp-bolt receiver enters an outer circumferential peripheral edge of the clamp body; and
the clamp-bolt receiver is spaced apart from a central axis of the clamp body; and
the clamp-bolt receiver is aligned at a right angle relative to the central axis of the clamp body; and
the clamp-bolt receiver is configured to receive a clamp bolt; and
the clamp body defines a lock-bolt receiver; and
the lock-bolt receiver extends between opposite lateral sides of the clamp body; and
the lock-bolt receiver is spaced apart from the central axis of the clamp body, and is aligned along the same direction as the central axis of the clamp body; and
the lock-bolt receiver is configured to receive a protrusion of the lock, and to receive, at least in part, a lock bolt; and
the lock-bolt receiver extends along a lock axis, once the lock-bolt receiver receives, at least in part, the lock.

13. The apparatus of claim 12, wherein:
the clamp body defines a jaw groove; and
the jaw groove extends between opposite lateral sides of the clamp body; and
the jaw groove is formed on a surface of a right-angled notch at a quarter quadrant of the clamp body; and
the jaw groove is spaced apart from the central axis of the clamp body, and is aligned along the same direction as the central axis of the clamp body; and
the jaw groove is configured to engage a rim section; and
the clamp includes a jaw portion; and
the jaw portion is movable relative to the clamp body of the clamp; and
the jaw portion defines a jaw-bolt receiver; and
the jaw-bolt receiver extends through the jaw portion; and
the jaw-bolt receiver is configured to receive the clamp bolt; and
the jaw portion defines the jaw groove; and
the jaw groove is configured to engage the rim section.

14. The apparatus of claim 13, wherein:
the clamp bolt is configured to extend through, at least in part, the jaw-bolt receiver defined by the jaw portion, and extend through, at least in part, the clamp-bolt receiver defined by the clamp body of the clamp; and
a washer is positioned against an end portion; and
the clamp bolt defines external threads formed on an elongated outer body of the clamp bolt, and extend from a distal end toward the end portion; and
the external threads of the clamp bolt are threadably engageable with the jaw-bolt receiver of the jaw portion; and
the external threads of the clamp bolt are not threadably engageable with the clamp-bolt receiver of the clamp body.

15. The apparatus of claim 14, wherein:
the clamp is configured to securely couple to the rim section of the musical drum; and
the jaw groove and the jaw groove engage opposite edges of the rim section; and
the jaw groove is made to engage one side of the rim section, and the jaw groove is made to engage the opposite lateral side of the rim section once the jaw portion is made to move toward the clamp-bolt receiver defined by the clamp body of the clamp.

16. The apparatus of claim 3, wherein:
the boom support includes a first body and a second body; and
the first body defines a first passageway extending through a central axis of the first body; and
the first passageway extends along a lock axis, once the first passageway receives, at least in part, the lock; and
the second body defines a second passageway extending through the central axis of the second body; and
the second passageway extends along the lock axis, once the second passageway receives, at least in part, the lock; and
the second body defines a boom passageway;
the boom passageway is configured to receive, at least in part, a length of the microphone boom; and
the boom passageway extends along a direction that is spaced apart from the central axis of the second body; and
the boom passageway extends at a right angle to the central axis of the second body; and
the boom passageway extends from an outer peripheral circumferential edge on one side of the second body to another side of the second body.

17. The apparatus of claim 16, wherein:
opposite lateral side faces of the first body are flat;
one flat side face of the first body is for abutment against a flat side face of the clamp; and
one lateral side face of the second body is flat, and is for abutment against another flat side face of the first body.

18. The apparatus of claim 3, wherein:
the boom support includes a first body and a second body; and
the clamp, the boom support and the lock are coaxially aligned along a lock axis in such a way that a second passageway of the second body, a first passageway of the first body, and a lock-bolt receiver of the clamp are centrally aligned along the lock axis.

19. The apparatus of claim 3, wherein:
the lock includes a lock body; and
a protrusion extends from the lock body; and
the protrusion defines a bolt receiver having interior threads therein; and
the bolt receiver is configured to receive, at least in part, a lock bolt; and
the lock bolt includes a shaped-head section extending from a shaft portion defining exterior threads thereon; and
exterior threads of the lock bolt are configured to engage the interior threads of the bolt receiver; and
a washer is installed to a shaft portion of the lock bolt; and
a distal end is configured to threadably connect to the interior of the bolt receiver.

20. The apparatus of claim 3, wherein:
the clamp includes a clamp body forming a cylindrical shaped body defining a right-angled notch positioned at a quarter quadrant of the clamp body; and
the boom support includes a first body and a second body each including a cylindrical-shaped body; and
the lock has a lock body including a disk-shaped body.
